(19) United States
(12) Patent Application Publication
(10) Pub. No.: US 2006/0206824 A1
(43) Pub. Date: Sep. 14, 2006

(54) Mobile communication device having scroll overlap adjustment capability and method of operation thereof

(75) Inventors: Assaf Landschaft, Munich (DE); Gal Wohlstadter, Munich (DE); Gil Wohlstadter, Munich (DE)

Correspondence Address: HITT GAINES P.C., P.O. BOX 832570, RICHARDSON, TX, 75083, US

(73) Assignee: Agere Systems Inc., Allentown, PA (US)

(21) Appl. No.: 11/076,681

(22) Filed: Mar. 10, 2005

(51) Int. Cl. G06F 9/00

(52) U.S. Cl. 715/752; 715/784; 715/864; 715/830

(57) ABSTRACT

To enable a user of a mobile communication devices to make a selection from a list of items with a minimum of input actions, a method for displaying information, in particular text information, on the display of a mobile communication device is introduced. The method calls for the display of the information to be scrolled with a user-selectable scroll overlap. A mobile communication device configured to carry out the method is also introduced.

### TECHNICAL FIELD OF THE INVENTION

The present invention is directed, in general, to mobile communication and, more specifically, to a mobile communication device having a scroll overlap adjustment capability and method of operation thereof.

### BACKGROUND OF THE INVENTION

As known, the dimensions of mobile communication devices, such as for example mobile telephones, personal digital assistants (PDAs) or mobile digital assistants (MDAs), are constantly decreasing. At the same time manufacturers put great effort into a convenient operation of such devices. One aspect is the reduction of input actions needed to reach a certain functionality, which is, for example, achieved by predictive text engines. Another aspect is the convenient readability of information displayed on the relatively small-sized displays of mobile communication devices.

When a user of a conventional mobile communication device browses through text information, such as, for example, a short message conforming to the Short Messaging Service (SMS) standard, he typically uses “up” and “down” keys. One up or down key stroke usually scrolls to the previous or next page respectively.

Depending on the user's reading habits and preferences, uncontrolled scrolling can impair reading by causing abrupt transitions from one page to the next and thereby disturbing the text flow. The user may even want to scroll a displayed information line by line instead page by page.

Accordingly, what is needed in the art is a new approach to displaying information, especially text information, on a mobile communication device and in particular to provide an improved method and mobile communication device enabling a user to adjust the display of information according to his reading habits and preferences.

### SUMMARY OF THE INVENTION

To address the above-discussed deficiencies of the prior art, the present invention provides, in one aspect, a method of displaying information on a display of a mobile communication device. In one embodiment, the method includes: (1) causing at least some of the information to be displayed on the display and (2) scrolling through the information with a user-selectable scroll overlap.

In another aspect, the present invention provides a mobile communication device. In one aspect, the mobile communication device includes: (1) an input configured to receive user commands, (2) a display for displaying information, (3) a text displayer configured to cause the information to be displayed on the display and (4) an overlap adjustor coupled to the text displayer and configured to scroll through the information with a user-selectable scroll overlap.

The foregoing has outlined preferred and alternative features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the invention.

### BRIEF DESCRIPTION OF THE DRAWINGS

For a more complete understanding of the invention, reference is now made to the following descriptions taken in conjunction with the accompanying drawing, in which:

FIG. 1 illustrates a schematic view of a mobile communication device having a scroll overlap adjustment capability constructed in accordance with the principles of the present invention;

FIG. 2 illustrates a high level block diagram of one embodiment of the communication device of FIG. 1;

FIG. 3 illustrates a display of one embodiment of an inventive mobile communication device capable of displaying seven text lines, depicting a scroll step for a scroll overlap value of zero;

FIG. 4 illustrates a display of one embodiment of an inventive mobile communication device capable of displaying seven text lines, depicting a scroll overlap value of two;

FIG. 5 illustrates a display of one embodiment of an inventive mobile communication device capable of displaying seven text lines, depicting a scroll overlap value of six; and

FIG. 6 illustrates a flow chart of one embodiment of a method of adjusting scroll overlap carried out according to the principles of the present invention.

### DETAILED DESCRIPTION

Before describing the FIGUREs directly, various aspects, embodiments and features of the present invention will be described. Accordingly, the invention proposes a method for displaying information, in particular text information, on the display of a mobile communication device, wherein the display of the information is scrolled with a user-selectable scroll overlap. Typically a scrolling step is caused by a user input, for example by pressing the up or down key of the keypad. Of course, the present invention applies to non-text information, such as an image, that exceeds the dimensions of the display and therefore must be scrolled to be viewed in its entirety.

The selectable scroll overlap provides added convenience for the user of a mobile communication device when reading displayed text information, especially text messages such as for example a received short message according to the Short Messaging Service (SMS) standard.

The inventive method is also advantageous for displaying text information that is structured as a list of items such as, for example, a functional menu of the mobile communication device, a telephone book listing or a list of stored pictures or sounds in a file folder.

Typically, text information is displayed on the display of a mobile communication device including at least two text lines. In this case, the method may provide that the user-selectable scroll overlap is defined by a value representing the number of overlapping lines between consecutive displayed pages. By means of the inventive method, when a user begins to read text, he can scroll the text with a scroll overlap, which is adjusted to his personal needs or preferences.

Since the user may prefer a different scroll overlap for different kinds of information, the method may include defining and storing different scroll overlap values for different kinds of information to be displayed.

Depending on the kind of information to be displayed, the display of the information may be scrolled in a vertical or a horizontal direction.

One embodiment of an inventive mobile communication device, by means of which in particular the method described above is executable, includes an input, such as a keyboard, configured to allow a user to provide user commands and a visual output, such as a display, configured to display information, in particular text information, wherein the device is adapted to scroll the display of the information with a user-selectable scroll overlap. The device may be adapted to scroll the information in response to input of a user command, for example by pressing the up or down key or may do so automatically as the user may desire.

Most preferably, a user-selectable scroll overlap value defines the scroll overlap. Accordingly, the mobile communication device may include a memory unit configured to store at least one scroll overlap value, the display being configured to scroll information by displaying consecutive pages with a number of overlapping lines given by the scroll overlap value.

The inventive device is especially suitable for displaying of text messages, in particular of short messages according to SMS standard, but it can also be advantageous for displaying of a menu that includes a list of user-selectable menu items.

For user convenience the inventive communication device advantageously includes means for defining and storing different scroll overlap values for different kinds of information to be displayed. Depending upon the kind of information to be displayed, the display of the information may be scrolled in either a vertical or horizontal direction.

The mobile communication device may be provided with a microprocessor having at least one associated memory unit. Based thereon an implementation software adapted for performing the inventive method can be easily implemented in the mobile communication device for providing a further improved flexibility of the inventive approach. Implementation in software is flexible relative to implementation in hardware.

Referring initially to FIG. 1, illustrated is a schematic view of a mobile communication device having a scroll overlap adjustment capability in accordance with the principles of the present invention. The mobile communication device 100 has a display 120 and a keyboard input 140. The display 120 is configured to display menus or lists through which a user ostensibly must navigate. The keyboard input 140 allows the user to select menu or list items and is illustrative of one type of input that the mobile communication device 100 may have. A touch-sensitive display is another possible type of input for such device.

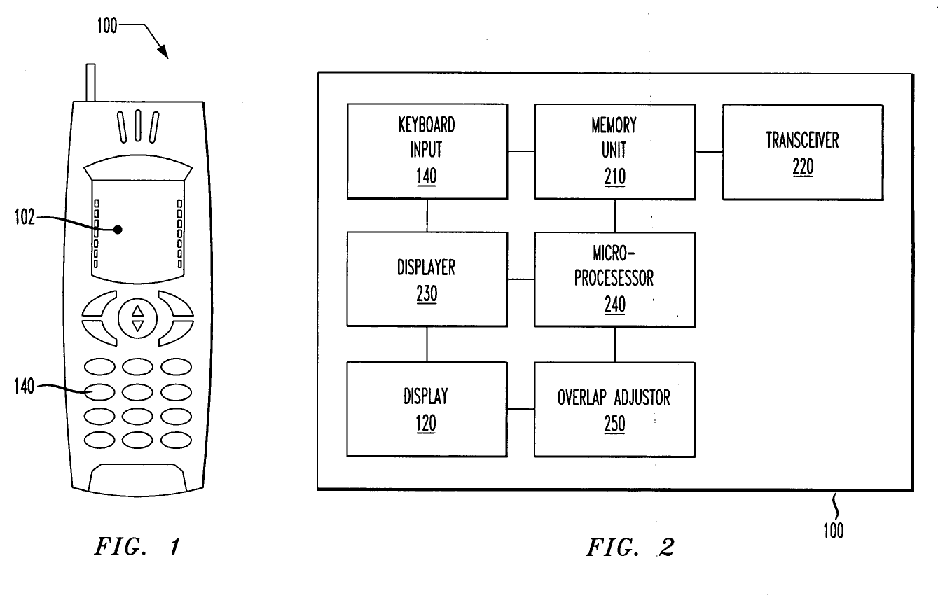

Turning now to FIG. 2, illustrated is a high level block diagram of one embodiment of the mobile communication device 100 of FIG. 1. The mobile communication device 100 illustrates the display 120 and keyboard input 140 of FIG. 1. The mobile communication device 100 further includes a memory unit 210, a transceiver 220, a text displayer 230, a micro-processor 240 and an overlap adjustor 250. The text displayer 230 and overlap adjustor 250 are shown in FIG. 2 as separate functional blocks and may be embodied in dedicated hardware in certain embodiments.

The memory unit 210 and the micro-processor 220 cooperate to store and execute sequences of software instructions, which may include one or more sequences to carry out the functions of the text displayer 230 and overlap adjustor 250 in certain alternative embodiments.

The text displayer 230 is configured to cause the information to be displayed on the display 120. The overlap adjustor 250 is configured to scroll the information on the display 120 with a user-selectable scroll overlap. The keyboard input 140 allows the user to prompt the text displayer to scroll the information on the display 140 and to make menu selections as may be desired.

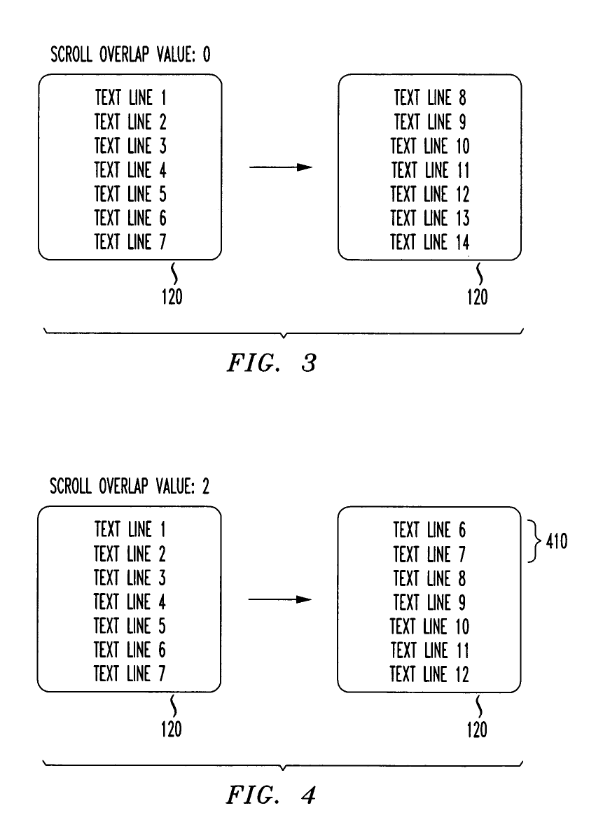

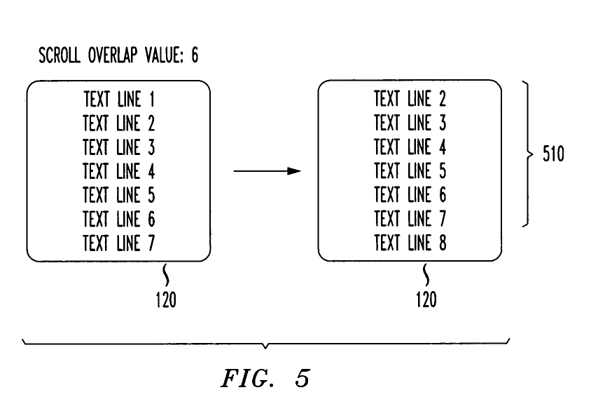

Turning now to FIGS. 3, 4 and 5, illustrated are displays (corresponding to the display 120 of FIG. 1) of one embodiment of an inventive mobile communication device capable of displaying seven text lines, depicting a scroll step for different scroll overlap values, specifically zero (FIG. 3), two (FIG. 4) and six (FIG. 5).

In this embodiment, the mobile communication device is a mobile telephone, the display 120 of which can display seven lines of text 310. In FIG. 3, a scroll step is shown for a scroll overlap value of zero. This selected value results in no effective overlap, i.e., the text is shown page by page, and by each up or down key stroke entirely new text is displayed.

If the user selects a scroll overlap value of two, as shown in FIG. 4, after each scroll step, two overlapping text lines 410 are displayed, which were already part of the previously displayed page.

A scroll overlap value of six, as shown in FIG. 4, has the effect that the text is scrolled line by line, because there are seven lines per screen and six lines 32 are overlapped when scrolled.

Each of the scroll overlap values exemplary described in FIGS. 3 to 5, may be separately selectable for separate users of the same mobile communication device, for displaying different kinds of information to the same user, or both. Therefore, with a mobile communication device constructed according to the principles of the present invention, the user is enabled to customize the way he browses through text on the device.

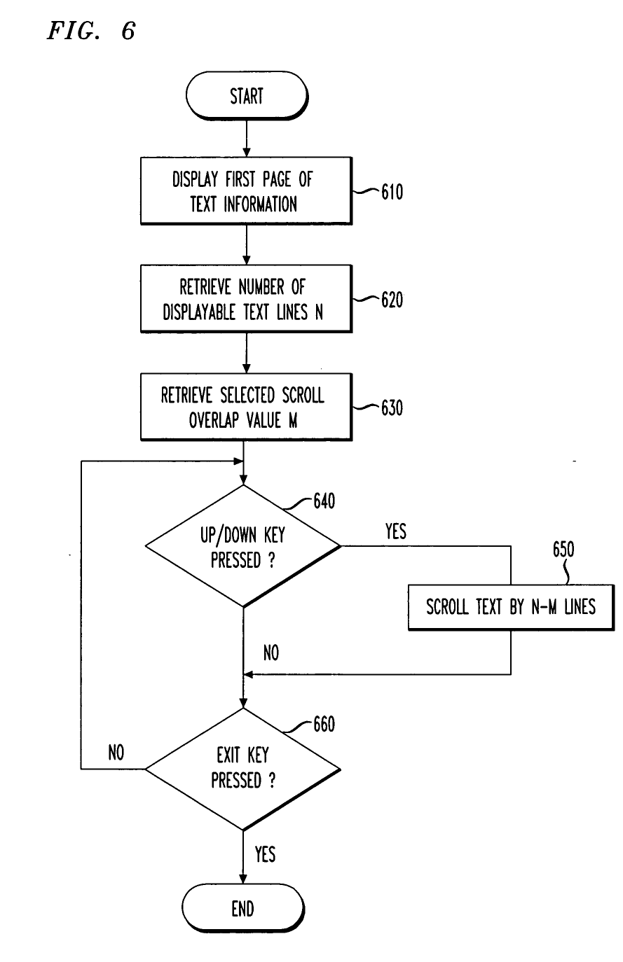

Turning now to FIG. 6, illustrated is a flow chart of one embodiment of a method of adjusting scroll overlap carried out according to the principles of the present invention. In this embodiment, the method includes displaying text information on the display of a mobile telephone. After displaying the first page of the text information in a step 610, the number of text lines, n, which can be simultaneously displayed on the mobile telephone's display, is retrieved in a step 620. Also the stored scroll overlap value, m, is retrieved in a step 630, being pre-selected by the user of the mobile telephone.

It is then determined whether the user has pressed the up or down key in a step 640 and, if not, whether the user has pressed the exit key in a step 660. As long as the user has pressed neither of these two keys, the key input is repeatedly checked. If the up or down key has been pressed, the displayed text information is scrolled in the according direction by a number of text lines calculated by the difference (n−m) in a step 650, continuing with the repeated determining of user input. If the user presses the exit key, displaying of the text information is aborted.

Although the present invention has been described in detail, those skilled in the art should understand that they can make various changes, substitutions and alterations herein without departing from the spirit and scope of the invention in its broadest form.

What is claimed is:

1. A method of displaying information on a display of a mobile communication device, comprising:
causing at least some of said information to be displayed on said display; and
scrolling through said information with a user-selectable scroll overlap.

2. The method as recited in claim 1 wherein said information is scrolled in response to user input.

3. The method as recited in claim 1 wherein said information comprises at least two text lines and said scroll overlap is defined by a value representing a number of overlapping lines between consecutive displayed pages.

4. The method as recited in claim 1 wherein said information to be displayed is a text message.

5. The method as recited in claim 4 wherein said text message is a Short Message System message.

6. The method as recited in claim 1 wherein said information is a menu including a list of user-selectable menu items.

7. The method as recited in claim 1 wherein said scroll overlap is user-selectable for different kinds of information.

8. The method as recited in claim 1 wherein said scrolling is performed in a selected one of:
a vertical direction, and
a horizontal direction.

9. The method as recited in claim 1 wherein a sequence of software instructions carries out said causing and said scrolling.

10. A mobile communication device, comprising:
an input configured to receive user commands;
a display for displaying information;
a text displayer configured to cause said information to be displayed on said display; and
an overlap adjustor coupled to said text displayer and configured to scroll through said information with a user-selectable scroll overlap.

11. The mobile communication device as recited in claim 10 wherein said overlap adjustor is configured to scroll said information in response to input of a user command.

12. The mobile communication device as recited in claim 10 comprising a memory unit configured to store at least one scroll overlap value and wherein said overlap adjustor is configured to scroll said information by displaying consecutive pages with a number of overlapping lines given by said scroll overlap value, said displayed information comprising at least two text lines.

13. The mobile communication device as recited in claim 10 wherein said information is a text message.

14. The mobile communication device as recited in claim 13 wherein said text message is a Short Message System message.

15. The mobile communication device as recited in claim 10 wherein said information is a menu including a list of user-selectable menu items.

16. The mobile communication device as recited in claim 10 wherein said scroll overlap is user-selectable for different kinds of information.

17. The mobile communication device as recited in claim 10 wherein said item designator performs said scrolling in a selected one of:
a vertical direction, and
a horizontal direction.

18. The mobile communication device as recited in claim 10 wherein said text displayer and said overlap adjustor are embodied in a sequence of software instructions.
